(19) United States
(12) Patent Application Publication
(10) Pub. No.: US 2010/0289704 A1
(43) Pub. Date: Nov. 18, 2010

(54) Electronic apparatus and antenna module thereof

(75) Inventors: Chun-Fei Yang, Taipei Hsien (TW); Hung-Chih Fu, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/461,219

(22) Filed: Aug. 5, 2009

(30) Foreign Application Priority Data
May 14, 2009 (TW) 098116069

(51) Int. Cl. H01Q 1/24

(52) U.S. Cl. 343/702

(57) ABSTRACT

An antenna structure for an electronic apparatus is disclosed. The electronic apparatus comprises a case composed of a first case and a second case, and the first case combines correspondingly with the second case. The antenna structure comprises an antenna element and a system antenna module. The antenna element is disposed on the inner side of the first case and comprises a connection portion. The system antenna module disposed in the case comprises a corresponding connection portion, and the position of the corresponding connection portion corresponds to the connection portion. The connection portion can be in contact with the corresponding connection portion to form an electrical connection between them by combining the first case and the second case.

### BACKGROUND OF THE INVENTION

1. Field of the Invention

The present invention relates to an electronic apparatus and an antenna structure thereof, and more particularly, to an electronic apparatus and its antenna structure, which can reduce the required inner installation space and save material cost, and can also improve the operation stability of the antenna circuit.

2. Description of the Related Art

Generally, electronic apparatuses are equipped with antenna modules for wireless network transmission. For example, a notebook computer is implemented with an antenna disposed at the display or the system board therein, and the notebook computer is also implemented with a wireless network transmission module at the system board; the wireless network transmission module is electrically coupled with the antenna through a cable to provide signal transmission.

In implementing the antenna and the wireless network transmission module, the relative positions of the antenna and the wireless network transmission module and the space required for containing them should be carefully designed to obtain good signal transmission effects and to save required space. In order to achieve the above object, some have proposed techniques which improve the traditional 3D antenna structures and use laser engraving techniques to form new planar antenna structures, which not only reduce the sizes of antennas but also facilitate more flexible antenna designs.

However, any kind of antenna structure needs cables to connect the antenna and the wireless network transmission module; the cables could cause additional costs to the antenna structure and affect the circuit arrangement. Furthermore, if any cable or circuit connection breaks off, it takes a lot of time and costs for the user or the manufacturer to replace the damaged components.

### SUMMARY OF THE INVENTION

It is an object of the present invention to provide an antenna structure which can reduce required inner installation space and save material cost.

In order to achieve the above object, the present invention discloses an antenna structure for an electronic apparatus; the electronic apparatus comprises a case, which comprises a first case and a second case, the first case correspondingly combines with the second case; the antenna structure comprises an antenna element and a system antenna module, the antenna element is disposed on an inner side of the first case, the antenna element comprises a connection portion; the system antenna module is disposed in the case, the system antenna module comprises a corresponding connection portion, wherein a position of the corresponding connection portion corresponds to the connection portion. The connection portion can be in contact with the corresponding connection portion to form an electrical connection between them by combining the first case and the second case. Therefore, when the cases of the electronic apparatus connect with each other, the antenna structure can provide signal transmission through the electrical connection and save circuit implementation cost.

The present invention discloses another antenna structure design for an electronic apparatus; the electronic apparatus comprises a case. The antenna structure comprises an antenna element, a system antenna module and at least one connection circuit, the antenna element is disposed on an inner side of the case, and the system antenna module is disposed in the case. The at least one connection circuit is electrically coupled between the antenna element and the system antenna module for transmitting a signal, wherein the at least one connection circuit is formed in an inner side of the case by a laser engraving method. In this design, the at least one connection circuit is attached to the case to reduce the use of physical circuits and to save the inner installation space.

The present invention discloses another antenna structure design for an electronic apparatus; the electronic apparatus comprises a case. The antenna structure comprises an antenna element, a system antenna module and at least one connection circuit, the antenna element is disposed on an inner side of the case and is formed by a laser engraving method, and the antenna element comprises a connection portion. The system antenna module is disposed in the case; and at least one connection circuit is electrically coupled between the antenna element and the system antenna module for transmitting a signal, the at least one connection circuit is connected with the connection portion by using a screw, a heat fusing method or a spot welding method.

The present invention discloses an electronic apparatus which can apply the above described antenna structures for various design requirements and structural arrangements and can provide antenna transmission functions.

### BRIEF DESCRIPTION OF THE DRAWINGS

FIG. 1 illustrates a structural view of an antenna structure in a first embodiment of the present invention;

FIG. 2A and FIG. 2B illustrate different combinational views of a connection portion connecting with a corresponding connection portion of the antenna structure in the first embodiment of the present invention;

FIG. 3 illustrates a structural view of an antenna structure in a second embodiment of the present invention;

FIG. 4 illustrates a view of an antenna structure in a third embodiment of the present invention; and

FIGS. 5A, 5B and 5C illustrate different combinational views of at least one connection circuit connecting with an antenna element in the third embodiment of the present invention.

### DETAILED DESCRIPTION OF THE PREFERRED EMBODIMENT

The advantages and innovative features of the invention will become more apparent from the following detailed description when taken in conjunction with the accompanying drawings.

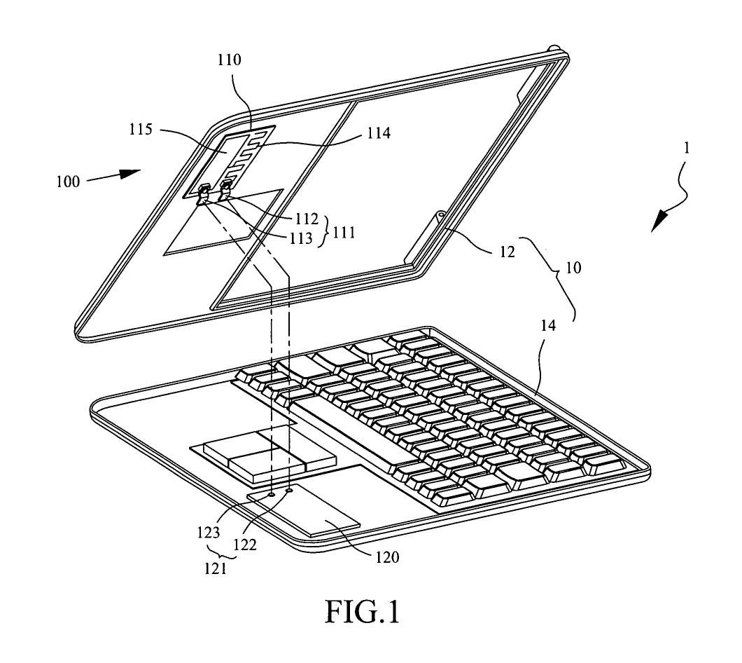

Please refer to FIG. 1 for a structural view of an antenna structure 100 in a first embodiment of the present invention. As shown in FIG. 1, the antenna structure 100 is applied in an electronic apparatus 1, the electronic apparatus 1 comprises a case 10, the case 10 comprises a first case 12 and a second case 14, the first case 12 correspondingly combines with the second case 14. In the following embodiment, the electronic apparatus 1 is illustrated by a notebook computer, but the present invention is not limited thereto. The antenna structure 100 comprises an antenna element 110 and a system antenna module 120, the antenna element 110 is disposed on the inner side of the first case 12, in this embodiment, the pattern of the antenna element 110 is formed by a laser engraving method, wherein the antenna element 110 can be formed by directly engraving the substrate on the inner side of the first case 12, or the antenna element 110 can be engraved and attached to the inner side of the first case 12.

The antenna element 110 comprises a connection portion 111, the connection portion 111 is provided for connecting the antenna element 110 with the system antenna module 120. The antenna element 110 further comprises an antenna portion 114 and a ground portion 115; the antenna portion 114 is electrically coupled with the ground portion 115 at a connection point which is treated as a signal feed-in point. The connection portion 111 comprises a first connection portion 112 disposed at the antenna portion 114 and a second connection portion 113 disposed at the ground portion 115.

The system antenna module 120 is disposed in the case 10, with different designs of the electronic apparatus 1, the system antenna module 120 can be disposed independently, or integrated with the system board of the electronic apparatus 1. The system antenna module 120 comprises a corresponding connection portion 121, a position of the corresponding connection portion 121 corresponds to the connection portion 111. The corresponding connection portion 121 comprises a first corresponding connection portion 122 and a second corresponding connection portion 123, the first corresponding connection portion 122 is provided for connecting with the first connection portion 112 of the antenna portion 114, and the second corresponding connection portion 123 is provided for connecting the second connection portion 113 of the ground portion 115, therefore, different signals are transmitted respectively.

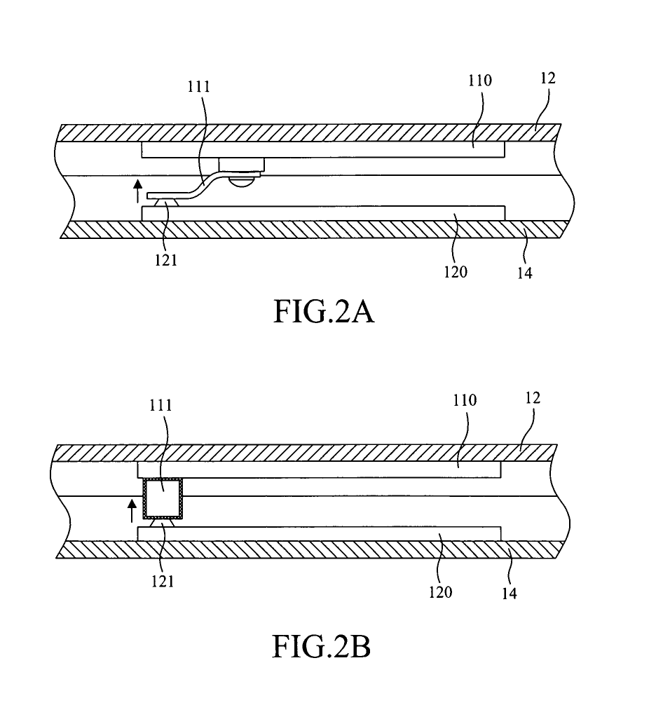

Please refer to FIG. 2A and FIG. 2B for different combinational views of a connection portion 111 connecting with a corresponding connection portion 121 of the antenna structure 100 in the first embodiment of the present invention. As shown in FIG. 1 and FIG. 2A, the connection portion 111 of the antenna structure 100 can be in contact with the corresponding connection portion 121 to form an electrical connection between them by combining the first case 12 and the second case 14. The connection portion 111 of the antenna element 110 is implemented with an elastic conducting structure for using its elastic characteristics to facilitate smooth combination of the first case 12 and the second case 14, and to make sure the corresponding connection portion 121 and the connection portion 111 is in contact with each other to form the electrical connection. Please also refer to FIG. 1, in this embodiment, the connection portion 111 (which includes the first connection portion 112 and the second connection portion 113) uses a spring structure to let a protruded portion of the spring plate be in contact with the corresponding connection portion 121 (which includes the first corresponding connection portion 122 and the second corresponding connection portion 123); and the corresponding connection portion 121 is implemented with a metal pad structure, since the metal pad structure is protruded from the surface of the system antenna module 120, making it easier for the corresponding connection portion 121 to be in contact with the connection portion 111. The corresponding connection portion 121 can be also implemented with a conductive gasket structure to make it protruded and compressible. The corresponding connection portion 121 can be a bare copper and directly connected to the connection portion 111 as shown in FIG. 1, FIG. 2A and FIG. 2B to form the electrical connection.

Also shown in FIG. 2B, in this embodiment, the connection portion 111 is implemented with a conductive gasket structure, when the first case 12 has combined with the second case 14, the conducting portion at the outer rim of the conductive gasket is electrically coupled with the corresponding connection portion 121, and the conductive gasket structure is flexible and compressible. Besides, the connection portion 111 can be implemented with an extendable thimble structure or the like; however, the present invention is not limited thereto.

Also shown in FIG. 1, the electronic apparatus 1 comprises the case 10 and the antenna structure 100 described above in the first embodiment; when the first case 12 combines with the second case 14 of the electronic apparatus 1, the antenna element 110 can be electrically coupled with the system antenna module 120 through the contact of the connection portion 111 and the corresponding connection portion 121 to enable the antenna function of the electronic apparatus 1. This design can totally eliminate the arrangement of connection circuits connecting the components of the antenna structure 100 and saves circuit cost.

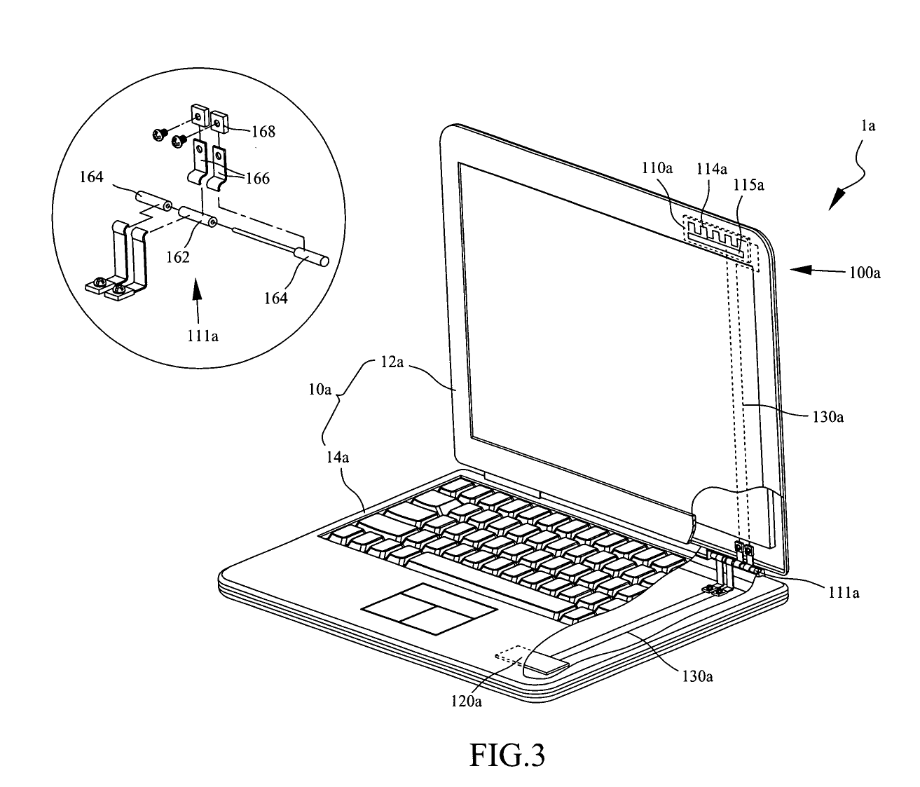

Please refer to FIG. 3 for a structural view of an antenna structure in a second embodiment of the present invention. As shown in FIG. 3, an antenna structure 100a is applied in an electronic apparatus 1a. The electronic apparatus 1a comprises a case 10a, wherein the case 10a comprises a first case 12a and a second case 14a, the first case 12a and the second case 14a is connected with each other through a connection portion 112a. The antenna structure 100a comprises an antenna element 110a, a system antenna module 120a and at least one connection circuit 130a, the antenna element 110a is disposed on an inner side of the case 10a, and the system antenna module 120a is disposed at the case 10a. The antenna element 110a comprises an antenna portion 114a and a ground portion 115a, the antenna portion 114a is electrically coupled with the ground portion 115a, the antenna portion 114a and the ground portion 115a are electrically coupled with the at least one connection circuit 130a respectively. In this embodiment, the antenna element 110a is disposed at the first case 12a, that is, the same side as the display; the system antenna module 120a is disposed at the second case 14a, that is, the same side as the system components. Due to inner space limitations of the electronic apparatus 1a, the antenna element 110a and the system antenna module 120a cannot be disposed together at the second case 14a; therefore, it is necessary to find a suitable space in the first case 12a for the antenna element 110a, and to connect the antenna element 110a and the system antenna module 120a through a circuit.

The at least one connection circuit 130a is electrically coupled between the antenna element 110a and the system antenna module 120a for transmitting signals, wherein the at least one connection circuit 130a is formed on an inner side of the case by a laser engraving method to eliminate the use of traditional physical circuits. In this embodiment, since the first case 12a and the second case 14a is connected with circuits, the antenna structure 100a uses the connection portion 111a having a specific structure as a hub for each connection circuit 130a, and the connection portion 111a enables the antenna element 110a and the system antenna module 120a to be electrically coupled with each other through each connection circuit 130a.

The connection portion 111a comprises a first signaling portion 162 and a second signaling portion 164, the second signaling portion 164 is disposed at both ends of the first signaling portion 162; the first signaling portion 162 and the second signaling portion 164 of the connection portion 111a are connected with different cables of the at least one connection circuit 130a through a plurality of metal parts 166 respectively to separate transmission signals, and joint parts 168 are used for fixing the first signaling portion 162 and the second signaling portion 164. Therefore, the connection portion 111a can provide signal transmission capabilities.

Also shown in FIG. 3, the electronic apparatus 1a comprises the case 10a and the antenna structure 100a described above in the second embodiment; with the design of the antenna structure 100a, when the at least one connection circuit 130a is formed on the inner side of the case 10a, the antenna element 110a at the first case 12a can transmit a signal to the system antenna module 120a at the second case 14a to enable the antenna function of the electronic apparatus 1a and to save circuit costs and inner space of the electronic apparatus 1a.

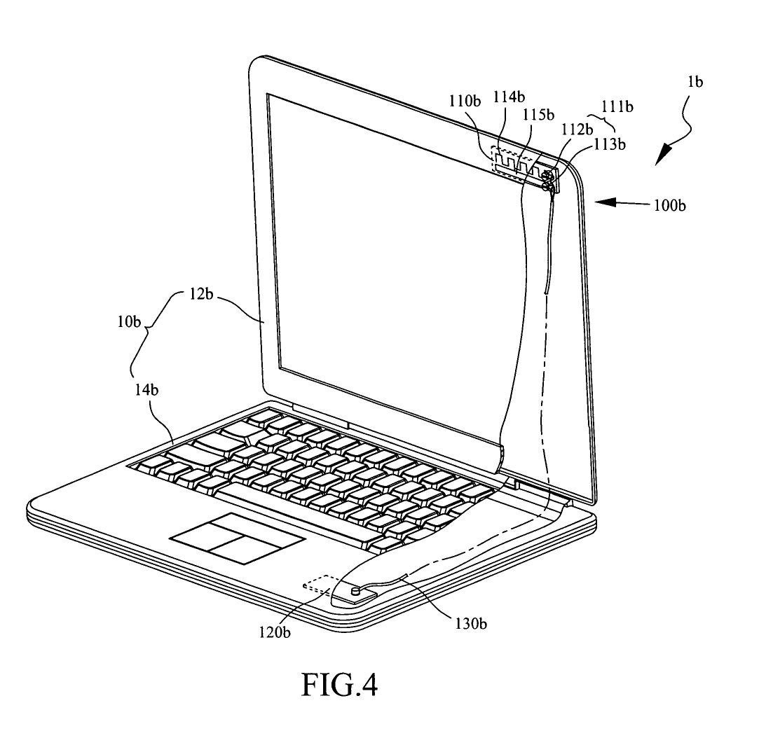

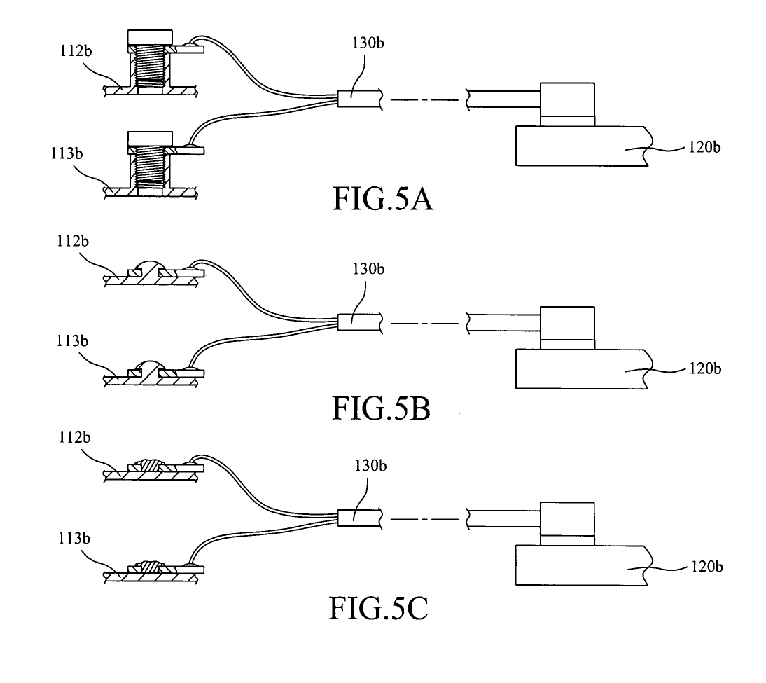

Please refer to FIG. 4 and FIG. 5A to 5C. FIG. 4 illustrates a view of an antenna structure 100b in a third embodiment of the present invention; and FIGS. 5A, 5B and 5C illustrate different combinational views of at least one connection circuit 130b connecting with an antenna element 110b in the third embodiment of the present invention. As shown in FIG. 4 and FIG. 5A, the antenna structure 100b is applied in an electronic apparatus 1b. The electronic apparatus 1b comprises a case 10b, wherein the case 10b comprises a first case 12b and a second case 14b. The antenna structure 100b comprises an antenna element 110b, a system antenna module 120b and at least one connection circuit 130b; the antenna element 110b is disposed on an inner side of the case 10b and is formed by a laser engraving method. The antenna element 110b comprises a connection portion 111b, which comprises a first connection portion 112b and a second connection portion 113b. The antenna element 110b further comprises an antenna portion 114b and a ground portion 115b, wherein the antenna portion 114b is electrically coupled with the ground portion 115b, the first connection portion 112b is disposed at the antenna portion 114b, and the second connection portion 113b is disposed at the ground portion 115b. The system antenna module 120b is disposed in the case 10b.

The at least one connection circuit 130b is electrically coupled between the antenna element 110b and the system antenna module 120b for transmitting signals. The at least one connection circuit 130b is guided to pass through a reserved portion of a pivot portion of the electronic apparatus 1b to connect the antenna element 110b and the system antenna module 120b, wherein the at least one connection circuit 130b is connected to the antenna element 110b through the connection portion 111b. Some electronic apparatuses 1b require physical circuits to act as the signal transmission lines between the antenna element 110b and the system antenna module 120b; therefore, the at least one connection circuit 130b is connected to the connection portion 111b of the antenna element 110b by a fixing method to ensure stable connection of the connection circuit 130b and the laser-engraved antenna element 110b, and to facilitate replacement of the at least one connection circuit 130b or the antenna element 110b when necessary. In this embodiment, each connection circuit 130b is fixed to the first connection portion 112b and the second connection portion 113b by a screw to maintain stable connection between each connection circuit 130b and the antenna element 110b.

Furthermore, as shown in FIG. 5B, each connection circuit 130b can be fixed to the first connection portion 112b and the second connection portion 113b by a heat fusing method, which heats the hot-melt material disposed on the first connection portion 112b and the second connection portion 113b to form a firm structure for fixing each connection circuit 130b to provide stable connection between them. When it is necessary to replace any component, the hot-melt material is removed, and then a newly replaced component can be fixed by the hot-melt material again. As shown in FIG. 5C, each connection circuit 130b can be fixed to the first connection portion 112b and the second connection portion 113b by a spot welding method, which can be repeated as the heat fusing method.

Therefore, by using the above-described design of the antenna structure 100b, the at least one connection circuit 130b can be connected with the connection portion 111b of the antenna element 110b through various connection methods to ensure stable connection between the two and to disconnect them for replacing any components when necessary, thereby facilitating the usability of the electronic apparatus 1b and saving maintenance costs.

It is noted that the above-mentioned embodiments are only for illustration, it is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An electronic apparatus comprising:
a case comprising a first case and a second case, the first case correspondingly combining with the second case; and
an antenna structure comprising:
an antenna element disposed on an inner side of the first case, the antenna element comprising a connection portion; and
a system antenna module disposed in the case, the system antenna module comprising a corresponding connection portion, wherein a position of the corresponding connection portion corresponds to the connection portion;
wherein the connection portion can be in contact with the corresponding connection portion to form an electrical connection between them by combining the first case and the second case.

2. The electronic apparatus as claimed in claim 1, wherein the antenna element is formed by a laser engraving method.

3. The electronic apparatus as claimed in claim 1, wherein the antenna element further comprises an antenna portion and a ground portion, the antenna portion is electrically coupled with the ground portion, the connection portion comprises a first connection portion disposed at the antenna portion and a second connection portion disposed at the ground portion; the corresponding connection portion comprises a first corresponding connection portion and a second corresponding connection portion, the first corresponding connection portion is provided for connecting with the first connection portion, the second corresponding connection portion is provided for connecting the second connection portion.

4. The electronic apparatus as claimed in claim 1, wherein the connection portion comprises an elastic conducting structure.

5. The electronic apparatus as claimed in claim 4, wherein the elastic conducting structure can be a thimble structure, a spring structure or a conductive gasket structure.

6. The electronic apparatus as claimed in claim 1, wherein the corresponding connection portion can be a bare copper, a metal pad structure or a conductive gasket structure.

7. An electronic apparatus comprising:
a case; and
an antenna structure comprising:
an antenna element disposed on an inner side of the case;
a system antenna module disposed in the case; and
at least one connection circuit electrically coupled between the antenna element and the system antenna module for transmitting a signal, wherein the at least one connection circuit is formed on an inner side of the case by a laser engraving method.

8. The electronic apparatus as claimed in claim 7, wherein the antenna element is formed by the laser engraving method.

9. The electronic apparatus as claimed in claim 7, wherein the antenna element comprises an antenna portion and a ground portion, the antenna portion is electrically coupled with the ground portion, and the antenna portion and the ground portion are electrically coupled with the at least one connection circuit respectively.

10. The electronic apparatus as claimed in claim 7, wherein the case comprises a first case and a second case, a connection portion is disposed between the first case and the second case for combining the first case and the second case, and the connection portion is electrically coupled with the antenna element and the system antenna module by the at least one connection circuit.

11. The electronic apparatus as claimed in claim 10, wherein the connection portion comprises a first signaling portion and a second signaling portion, the second signaling portion is disposed at both ends of the first signaling portion and is provided for connecting with different cables of the at least one connection circuit.

12. The electronic apparatus as claimed in claim 10, wherein the connection portion is connected with the at least one connection circuit by a plurality of metal parts.

13. An electronic apparatus comprising:
a case; and
an antenna structure comprising:
an antenna element disposed on an inner side of the case, wherein the antenna element is formed by a laser engraving method, and the antenna element comprises a connection portion;
a system antenna module disposed in the case; and
at least one connection circuit electrically coupled with the antenna element and the system antenna module for transmitting a signal, wherein the at least one connection circuit is connected with the antenna element through the connection portion.

14. The electronic apparatus as claimed in claim 13, wherein the at least one connection circuit is connected with the connection portion by using a screw, a heat fusing method or a spot welding method.

15. The electronic apparatus as claimed in claim 13, wherein the antenna element comprises an antenna portion and a ground portion, the antenna portion is electrically coupled with the ground portion; the connection portion comprises a first connection portion disposed at the antenna portion and a second connection portion disposed at the ground portion, the first connection portion is electrically coupled with the second connection portion by the at least one connection circuit.
